(19) United States
(12) Patent Application Publication
(10) Pub. No.: US 2021/0006512 A1
(43) Pub. Date: Jan. 7, 2021

(54) PACKET FORWARDING APPARATUS, NETWORK SYSTEM, AND PACKET FORWARDING METHOD

(71) Applicant: FUJITSU LIMITED, Kawasaki-shi (JP)

(72) Inventors: Takahiro FURUKAWA, Kawasaki (JP); Koji YANAI, Machida (JP); Hiroaki Yoshida, Kawasaki (JP)

(73) Assignee: FUJITSU LIMITED, Kawasaki-shi (JP)

(21) Appl. No.: 16/913,297

(22) Filed: Jun. 26, 2020

(30) Foreign Application Priority Data
Jul. 1, 2019 (JP) 2019-122933

(51) Int. Cl. H04L 12/939; H04L 12/761; H04L 12/707

(52) U.S. Cl. CPC H04L 49/557; H04L 49/555; H04L 45/22; H04L 45/16

(57) ABSTRACT

A packet forwarding apparatus includes a transmitter configured to transmit a multicast packet requesting a response to a plurality of relay apparatuses each configured to relay a packet in a network, a memory configured to store apparatus information relating to on a relay processing status of the packet in each of the plurality of relay apparatuses, and a processor configured to update the apparatus information according to whether the response is received from each of the plurality of relay apparatuses, and switch a forwarding destination of the packet from a relay apparatus with no response to a relay apparatus with the response among the plurality of relay apparatuses according to updated data in the apparatus information.

### CROSS-REFERENCE TO RELATED APPLICATION

This application is based upon and claims the benefit of priority of the prior Japanese Patent Application No. 2019422933, filed on Jul. 1, 2019, the entire contents of which are incorporated herein by reference,

### FIELD

Embodiments discussed herein relate to a packet forwarding apparatus, a network system, and a packet forwarding method.

### BACKGROUND

A monitoring control network including a monitoring control apparatus such as a network element operating system (NE-OpS) is used in order to monitor and control a network for main signals. For saving the facility cost for the monitoring control network, for example, routers are coupled to each other not in a mesh form but in a tree form, and forward packets from the monitoring control apparatus to the network through a predetermined path without using particular routing protocol.

Since a large scale network has a high risk of the occurrence of a failure, it is preferable to configure redundant forward paths for monitoring control packets. However, routing protocol such as open shortest path first (OSPF) is inefficient for the routers coupled in the tree form.

To address this, for example, there is a conceivable method of detecting a failure in a coupled node in a network or a forward path for a monitoring control packet based on whether an echo response to an echo request according to Internet Control Message Protocol (ICMP) is received or not (for example, see Japanese Laid-open Patent Publication Nos. 11-112519 and 2014-3451), and switching the forward path based on the detection result.

### SUMMARY

According to an aspect of the embodiments, a packet forwarding apparatus includes a transmitter configured to transmit a multicast packet requesting a response to a plurality of relay apparatuses each configured to relay a packet in a network, a memory configured to store apparatus information relating to on a relay processing status of the packet in each of the plurality of relay apparatuses, and a processor configured to update the apparatus information according to whether the response is received from each of the plurality of relay apparatuses, and switch a forwarding destination of the packet from a relay apparatus with no response to a relay apparatus with the response among the plurality of relay apparatuses according to updated data in the apparatus information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating an example of a network system;

FIG. 2 is a diagram illustrating an example of forward path switching using ICMP echo requests;

FIG. 3 is a diagram illustrating an example of forward path switching using a multicast packet;

FIG. 4 is a diagram illustrating another example of forward path switching using a multicast packet;

FIG. 5 is a configuration diagram illustrating an example of an upper layer 3 switch;

FIG. 6 is a configuration diagram illustrating an example of a lower layer 3 switch;

FIG. 7 is a sequence diagram illustrating an example of communications in the case where no failure occurs;

FIG. 8 is a diagram illustrating an example of an address list, an apparatus management table, and a routing table in the case where no failure occurs;

FIG. 9 is a sequence diagram illustrating an example of communications in the case where a failure occurs in a forward path between an upper layer 3 switch and a forwarding destination lower layer 3 switch;

FIG. 10 is a diagram illustrating an example of the address list, the apparatus management table, and the routing table in the case where the failure occurs in a forward path between the upper layer 3 switch and the forwarding destination lower layer 3 switch;

FIG. 11 is a sequence diagram illustrating an example of communications in the case where a failure occurs in a forward path between the upper layer 3 switch and a non-forwarding destination lower layer 3 switch;

FIG. 12 is a diagram illustrating an example of the address list, the apparatus management table, and the routing table in the case where the failure occurs in the forward path between the upper layer 3 switch and the non-forwarding destination lower layer 3 switch;

FIG. 13 is a sequence diagram illustrating an example of communications in the case where a failure occurs in a forward path between a lower layer 3 switch and a lower layer 3 switch at the next node in the ring network;

FIG. 14 is a sequence diagram illustrating another example of communications in the case where a failure occurs in the forward path between the lower layer 3 switch and the lower layer 3 switch at the next node in the ring network;

FIG. 15 is a sequence diagram illustrating another example of communications in the case where a failure occurs in a forward path between a non-forwarding destination lower layer 3 switch and a lower layer 3 switch at the next node;

FIG. 16 is a sequence diagram illustrating another example of communications in the case where a failure occurs in the forward path between the non-forwarding destination lower layer 3 switch, and the lower layer 3 switch at the next node;

FIG. 17 is a flowchart illustrating an example of operations of the upper layer 3 switch;

FIG. 18 is a flowchart illustrating an example of update processing;

FIG. 19 is a flowchart illustrating an example of request message reception processing by the lower layer 3 switch; and

FIG. 20 is a flowchart illustrating an example of processing by the lower layer 3 switch in the case where a failure occurs in the forward path between the lower layer 3 switch and the lower layer 3 switch at the next node,

### DESCRIPTION OF EMBODIMENTS

The routers in the monitoring control network have to separately issue ICMP echo requests to all the coupled nodes in the network, and accordingly the processing for these requests may place a high burden. The burden of the monitoring control network may also be high because a large number of packets for the echo requests and the echo responses flow in the monitoring control network.

This requests use of high performance and high cost routers as the routers in the monitoring control network, and makes it difficult to save the facility cost.

Under these circumstances, the embodiments are intended to provide a packet forwarding apparatus, a network system, and a packet forwarding method capable of reducing the burden for packet path switching.

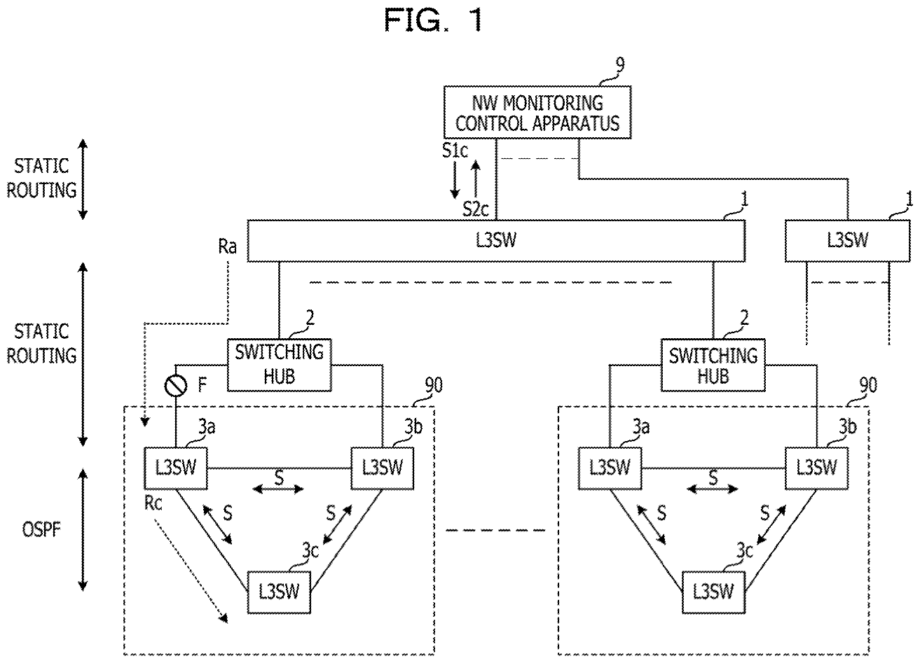

FIG. 1 is a configuration diagram illustrating an example of a network system. The network system includes a network (NW) monitoring control apparatus 9 such as NE-OpS, multiple upper layer 3 switches (L3SWs) 1 such as routers, multiple sets of lower layer 3 switches 3a to 3c, and multiple switching hubs 2. The network system is a monitoring control network for monitoring control by the network monitoring control apparatus 9.

The network monitoring control apparatus 9 is coupled to the multiple upper layer 3 switches 1. Each upper layer 3 switch 1 is coupled to the lower layer 3 switches 3a and 3b via the switching hubs 2. In this way, the upper layer 3 switch 1 is coupled to the lower layer 3 switches 3a and 3b in a tree form.

The lower layer 3 switches 3a to 3c in one set are coupled to each other to constitute a ring network 90. The ring network 90 is an example of a network to be monitored by the network monitoring control apparatus 9 and the lower layer 3 switches 3a to 3c mutually transmit and receive packets containing main signals (hereinafter, referred to as “main signal packets”) S, and packets for the monitoring control of the ring network 90 (hereinafter, referred to as “monitoring control packets”).

To each of the lower layer 3 switches 3a to 3c, a client network (not illustrated) is coupled. Each of the lower layer 3 switches 3a to 3c controls a forward path for main signal packets S by using OSPF as an example of routing protocol, and has a function of Ethernet ring protection (ERP) (Ethernet: registered trademark). The form of the ring network 90 is not limited, and a mesh network may be provided instead of the ring network 90.

The upper layer 3 switch 1 functions as a gateway between the network monitoring control apparatus 9 and the ring networks 90. The upper layer 3 switch 1 forwards a packet S1c for monitoring control (hereinafter, referred to as a “monitoring control packet”) from the network monitoring control apparatus 9 to each ring network 90, and forwards a monitoring control packet S2c from the ring network 90 to the network monitoring control apparatus 9.

The monitoring control packet S1c transmitted by the network monitoring control apparatus 9 contains, for example, various kinds of control instructions to the lower layer 3 switches 3a to 3c. The monitoring control packet S2c transmitted by the lower layer 3 switch 3a to 3c contains, for example, a notification of any of various kinds of failures related to the transmission of a main signal packet 5, which has been detected by the lower layer 3 switch 3a to 3c. The upper layer 3 switch 1 is an example of a packet forwarding apparatus and the monitoring control packet S1c is an example of a packet for monitoring control of a network.

The path control between the network monitoring control apparatus 9 and each upper layer 3 switch 1 is performed by not using particular routing protocol, but using static routing in which a packet is forwarded through a particular forward path depending on a destination. The path control between the upper layer 3 switch 1 and the ring network 90 also uses static routing.

For example, the upper layer 3 switch 1 forwards the monitoring control packet S1c through a forward path Ra leading, via the switching hub 2, to the lower layer 3 switch 3a out of the two lower layer 3 switches 3a and 3b directly coupled to the switching hub 2. In the ring network 90, the monitoring control packet S1c is forwarded by each of the lower layer 3 switches 3a to 3c according to OSPF, for example, along a forward path Rc leading to the lower layer 3 switch 3c from the lower layer 3 switch 3a In the ring network 90, the monitoring control packet S1c is forwarded in-band within the same band used for main signal packets S.

In this way, the lower layer 3 switches 3a and 3b relay the monitoring control packet depending on the destination in the ring network 90. The lower layer 3 switches 3a and 3b are an example of multiple relay apparatuses.

However, for example, when a failure (for example, such as a transmission line break) F occurs in the forward path between the switching hub 2 and the lower layer 3 switch 3a, the monitoring control packet S1c is lost without reaching the lower layer 3 switch 3a from the switching hub 2. For this reason, the network monitoring control apparatus 9 is disabled from performing the monitoring control of the ring network 90.

To address this, the upper layer 3 switch 1 issues ICMP echo requests to the lower layer 3 switches 3a and 3b and thereby checks the status of each of the lower layer 3 switches 3a and 3b based on whether the echo responses are received or not as in an example described below. Thus, the upper layer 3 switch 1 is capable of detecting the lower layer 3 switch 3a or 3b to which the monitoring control packet. S1c fails to be forwarded due to the failure F, and thereby switching the forward path for the monitoring control packet S1c.

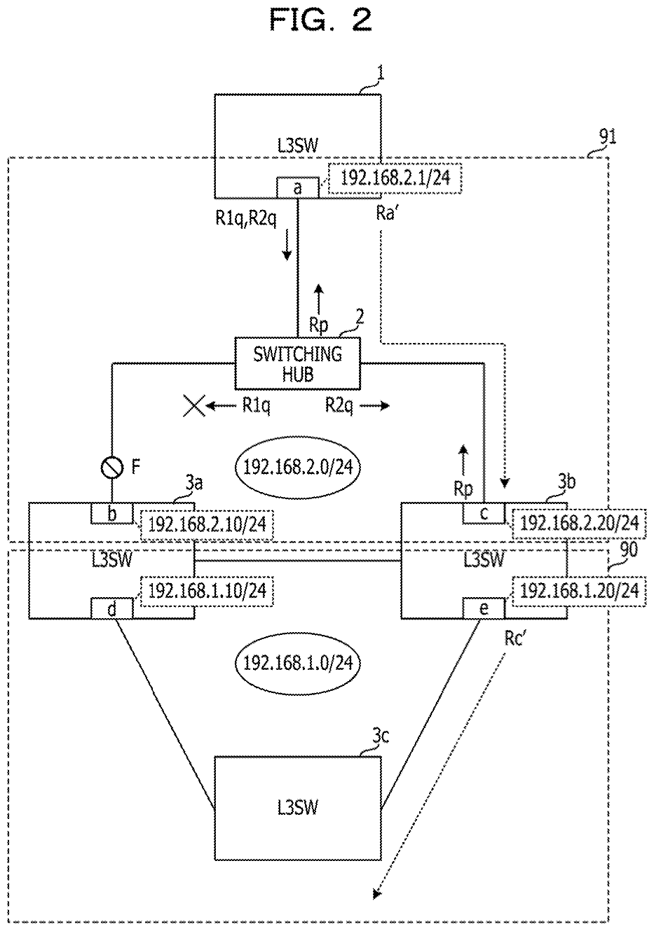

FIG. 2 is a diagram illustrating an example of forward path switching using ICMP echo requests. In FIG. 2, constituents in common with FIG. 1 are denoted by the same reference signs, and the explanation thereof is omitted. The lower layer 3 switch 3a is set as a static routing path between the upper layer 3 switch 1 and the ring network 90.

The upper layer 3 switch 1 is coupled to the switching hub 2 via a port a set with, for example, an Internet Protocol (IP) address “192.168.2.1/24”.

The lower layer 3 switch 3a is coupled to the switching hub 2 via a port b set with, for example, an IP address “192.168.2.10/24”. The lower layer 3 switch 3b is coupled to the switching hub 2 via a port c set with, for example, an IP address “192.168.2.20/24”.

The ports a to c and the switching hub 2 constitute a layer 2 network 91. An IP address scheme of the layer 2 network 91 is, for example, “192.168.2.0/24”.

The lower layer 3 switch 3a is coupled to the lower layer 3 switch 3c via a port d set with, for example, an IP address “192.168.1.10/24”. The lower layer 3 switch 3b is coupled to the lower layer 3 switch 3c via a port e set with, for example, an IP address “192.168.1.20/24”.

The ports d and e and the lower layer 3 switch 3c constitute the ring network 90. An IP address scheme of the ring network 90 is, for example, “192.168.1.0/24”.

The upper layer 3 switch 1, for example, periodically transmits an echo request Rig to the lower layer 3 switch 3a and transmits an echo request R2q to the lower layer 3 switch 3b. For this transmission, in the upper layer 3 switch 1, the IP address “192.168.2.10/24” of the lower layer 3 switch 3a and the IP address “192.168.2.20/24” of the lower layer 3 switch 3b are set in advance as the destinations of the echo requests R1q and R2q.

The echo request. R1q is forwarded to the lower layer 3 switch 3a by the switching hub 2, and the echo request R2q is forwarded to the lower layer 3 switch 3b by the switching hub 2. For example, when a failure F occurs in the forward path between the switching hub 2 and the lower layer 3 switch 3a, the echo request R1q is lost without reaching the lower layer 3 switch 3a. For this reason, the lower layer 3 switch 3a fails to transmit a response to the echo request R1q.

On the other hand, the lower layer 3 switch 3b receives the echo request R2q because no failure occurs in the forward path between the switching hub 2 and the lower layer 3 switch 3b. For this reason, the lower layer 3 switch 3b is able to transmit an echo response Rp to the echo request R2q to the upper layer 3 switch 1. The echo response Rp is forwarded to the upper layer 3 switch 1 by the switching hub 2.

The upper layer 3 switch 1 detects that no echo response is received from one of the lower layer 3 switches 3a and 3b, namely the lower layer 3 switch 3a, but the echo response Rp is received from the other lower layer 3 switch 3b. According to the detection result, for example, the upper layer 3 switch 1 switches the next hop for packets addressed to the ring network 90 from the lower layer 3 switch 3a set as the static routing path to the other lower layer 3 switch 3b. This switches the forward path for the monitoring control packet from the forward path Ra (see FIG. 1) leading to the one lower layer 3 switch 3a to a forward path Ra′ leading to the other lower layer 3 switch 3b.

In the ring network 90, the lower layer 3 switch 3b sets a forward path Rc ′ leading to the lower layer 3 switch 3c from the lower layer 3 switch 3b as the forward path for the monitoring control packet according to OSPF and forward the monitoring control packet through the forward path Rc′.

Thus, when the lower layer 3 switch 3a set as the static routing path is disabled from receiving the monitoring control packet, the upper layer 3 switch 1 is enabled to transmit the monitoring control packet to the other lower layer 3 switch 3b. In this way, the redundant forward paths between the upper layer 3 switch 1 and the ring network 90 enable the network monitoring control apparatus 9 to continue monitoring control of the ring network 90 even when a failure F occurs.

According to the above method, however, the upper layer 3 switch 1 issues the ICMP echo requests R1q and R2q to the lower layer 3 switches 3a and 3b separately in the ring network 90. Hence, the burden of the above processing may become higher as the network scale becomes larger. The burden of the switching hub 2 may also increase because a larger number of packets for the echo requests R1q and R2q and the echo responses Rp pass through the switching hub 2.

The IP addresses of the lower layer 3 switches 3a and 3b have to be set in advance as the destinations of the echo requests R1q and R2q, which also places a burden of processing for setting a large number of IP addresses in the upper layer 3 switch 1.

To address this, in a network system of an embodiment, an upper layer 3 switch 1 transmits a multicast packet requesting a response to lower layer 3 switches 3a and 3b to the lower layer 3 switches 3a and 3b, and thereby checks the statuses of the lower layer 3 switches 3a and 3b. Thus, the upper layer 3 switch 1 is capable of detecting the lower layer 3 switch 3a or 3b to which the monitoring control packet S1c fails to be forwarded due to a failure F, and thereby capable of switching the forward path for the monitoring control packet S1c without issuing the multiple echo requests R1q and R2q, which would otherwise place a burden.

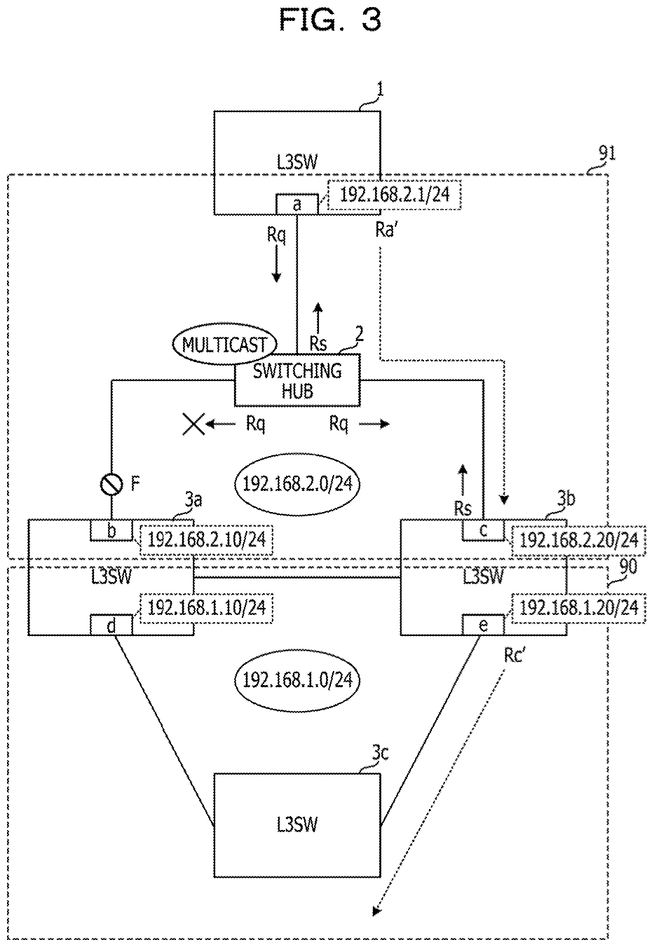

FIG. 3 is a diagram illustrating an example of forward path switching using a multicast packet. In FIG. 3, constituents in common with FIG. 2 are denoted by the same reference signs, and the explanation thereof is omitted. The lower layer 3 switch 3a is set as a static routing path between the upper layer 3 switch 1 and the ring network 90.

The upper layer 3 switch 1, for example, periodically transmits a multicast packet Rq requesting a response to the lower layer 3 switches 3a and 3b to the lower layer 3 switches 3a and 3b. The switching hub 2 recognizes the multicast packet Rq based on the destination address and forwards the multicast packet Rq to the lower layer 3 switches 3a and 3b.

For example, when a failure F occurs in the forward path between the switching hub 2 and the lower layer 3 switch 3a, the multicast packet Rq is lost without reaching the lower layer 3 switch 3a. For this reason, the lower layer 3 switch 3a fails to transmit a response to the multicast packet Rq.

On the other hand, the lower layer 3 switch 3b receives the multicast packet Rq because no failure occurs in the forward path between the switching hub 2 and the lower layer 3 switch 3b. For this reason, the lower layer 3 switch 3b is able to transmit a response Rs to the multicast packet Rq to the upper layer 3 switch 1. The response Rs is forwarded to the upper layer 3 switch 1 by the switching hub 2.

The upper layer 3 switch 1 detects that no response is received from one of the lower layer 3 switches 3a and 3b, namely the lower layer 3 switch 3a, but the response Rs is received from the other lower layer 3 switch 3b. According to the detection result, for example, the upper layer 3 switch 1 switches the next hop for packets addressed to the ring network 90 from the lower layer 3 switch 3a set as the static routing path to the other lower layer 3 switch 3b. This switches the forward path for the monitoring control packet from the forward path Ra (see FIG. 1) leading to the one lower layer 3 switch 3a to a forward path Ra′ leading to the other lower layer 3 switch 3b.

In the ring network 90, the lower layer 3 switches 3a to 3c set a forward path Rc′ leading to the lower layer 3 switch 3c from the lower layer 3 switch 3b as the forward path for the monitoring control packet according to OSPF and forward the monitoring control packet through the forward path Rc′.

Thus, when the lower layer 3 switch 3a set as the static routing path is disabled from receiving the monitoring control packet, the upper layer 3 switch 1 is enabled to transmit the monitoring control packet to the other lower layer 3 switch 3b.

The present example describes the case where the failure occurs in the forward path between the switching hub 2 and the lower layer 3 switch 3a. Instead, when a failure occurs in a forward path in the ring network 90, the forward path is switched in the following method.

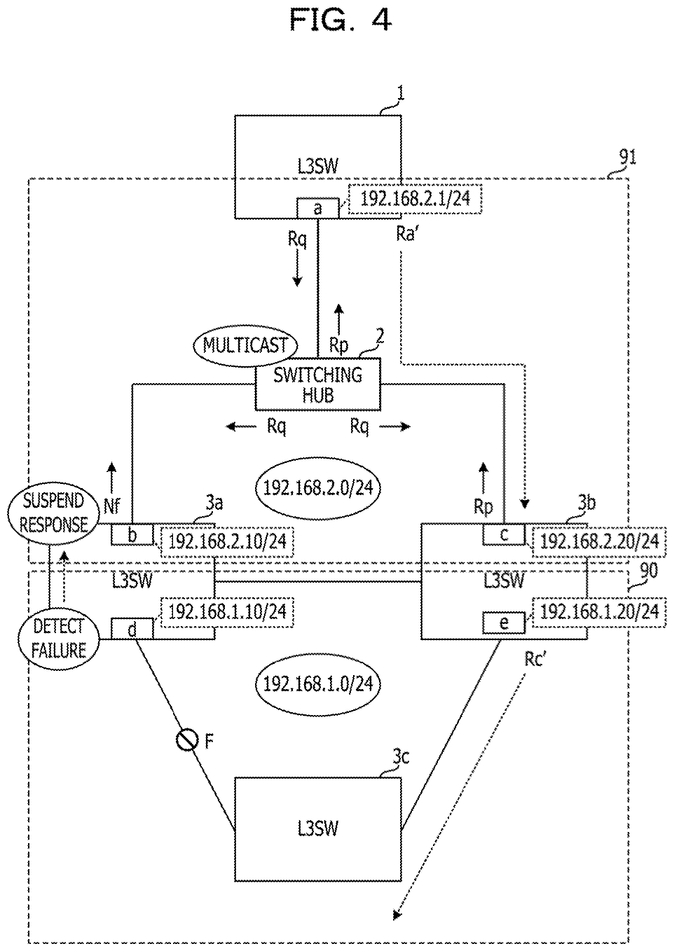

FIG. 4 is a diagram illustrating another example of forward path switching using a multicast packet. In FIG. 4, constituents in common with FIG. 3 are denoted by the same reference signs, and the explanation thereof is omitted. The lower layer 3 switch 3a is set as a static routing path between the upper layer 3 switch 1 and the ring network 90.

The lower layer 3 switch 3a is able to receive the multicast packet Rq unlike the example in FIG. 3. For this reason, the lower layer 3 switch 3a suspends transmission of a response when detecting a failure in the forward path to the lower layer 3 switch 3c at the next node. Thus, the upper layer 3 switch 1 does not receive the response from the lower layer 3 switch 3a, and therefore switches the forwarding destination of the monitoring control packet addressed to the ring network 90 to the other lower layer 3 switch 3b.

In the ring network 90, the lower layer 3 switches 3a to 3c set a forward path Re leading to the lower layer 3 switch 3c from the lower layer 3 switch 3b as the forward path for the monitoring control packet according to OSPF and forward the monitoring control packet through the forward path Rc′. For this reason, it is possible to forward the monitoring control packet addressed to the ring network 90 from the upper layer 3 switch 1 to each of the lower layer 3 switches 3a to 3c in the ring network 90.

When the lower layer 3 switch 3a detects a failure in the forward path to the lower layer 3 switch 3c at the next node under the condition where the multicast packet Rq is not transmitted, the lower layer 3 switch 3a transmits a failure notification Nf to the upper layer 3 switch 1. Thus, the upper layer 3 switch 1 is able to switch the forwarding destination of the monitoring control packet to the other lower layer 3 switch 3b as in the above case.

Next, a configuration of the upper layer 3 switch 1 is described.

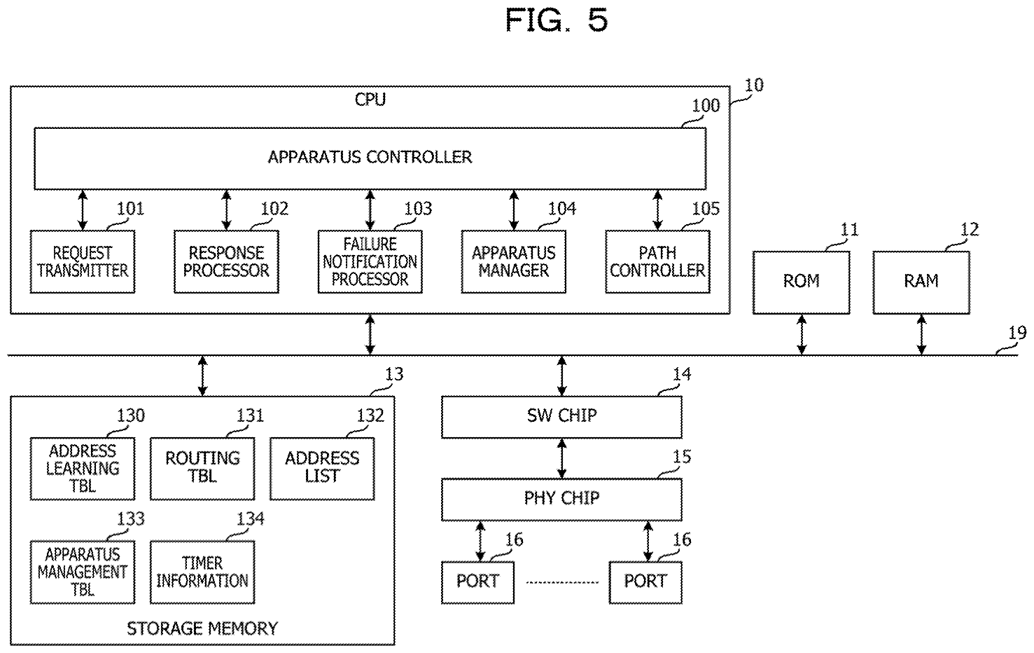

FIG. 5 is a configuration diagram illustrating an example of the upper layer 3 switch 1. The upper layer 3 switch 1 includes a central processing unit (CPU) 10, a read-only memory (ROM) 11, a random-access memory (RAM) 12, a storage memory 13, a switch (SW) chip 14, a physical layer (PHY) chip 15, and multiple ports 16. The CPU 10 is coupled to the ROM 11, the RAM 12, the storage memory 13, the SW chip 14, and the multiple ports 16 via a bus 19 in a manner capable of inputting and outputting signals to and from them.

The ROM 11 stores therein a program for driving the CPU 10. The RAM 12 functions as a working memory for the CPU 10.

The ports 16 transmit and receive various kinds of packets to and from other apparatuses. Each of the ports 16 includes, for example, a laser diode and a modulator for transmitting packets, a photo diode and a demodulator for receiving packets, and so on. Each of the ports 16 forwards packets such as a monitoring control packet and a multicast packet. Here, one of the ports 16 serves as the above port a.

The PHY chip 15 is composed of hardware such, for example, as an application-specified integrated circuit (ASIC). The PHY chip 15 is coupled to all the ports 16, and inputs and outputs packets to and from the ports 16. The PHY chip 15 processes a physical layer of a packet transmitted or received by each port 16.

The SW chip 14 is composed of hardware such, for example, as an ASIC. The SW chip 14 is coupled to all the ports 16 via the PHY chip 15, and exchanges packets between the ports 16. The SW chip 14 identifies the destination of a packet outputted from each port 16 and outputs the packet to the port 16 specified by the destination.

The storage memory 13 stores therein an address learning table (TBL) 130, a routing table (TBL) 131, an address list 132, an apparatus management table (TBL) 133, and timer information 134. The address learning table 130 is managed by the SW chip 14, and is referred to by the SW chip 14 in packet forwarding with a layer 2 function.

The routing table 131, the address list 132, and the apparatus management table 133 are managed by the CPU 10. The SW chip 14 forwards the monitoring control packet to the ring network 90 based on the routing table 131. The SW chip 14 is an example of a forwarding processing unit.

The address list 132 registers therein the IP addresses of the lower layer 3 switches 3a and 3b from which responses to the multicast packet are received. The address list 132 is used to detect a change from response reception to non-reception or vice versa from each of the lower layer 3 switches 3a and 3b.

The apparatus management table 133 is an example of apparatus information concerning a relay processing status of a monitoring control packet in each of the lower layer 3 switches 3a to 3c. The apparatus management table 133 registers a static routing path registration status and a forwarding status of each of the lower layer 3 switches 3a and 3b concerning the monitoring control packet addressed to the ring network 90, the static routing path registration status indicating whether the corresponding lower layer 3 switch 3a or 3b is registered in the routing table 131. The timer information 134 indicates a time interval between multicast packet transmissions and is set by, for example, the network monitoring control apparatus 9. The storage memory 13 is an example of a memory configured to store the apparatus information.

The CPU 10 loads the program from the ROM 11, and forms functions of an apparatus controller 100, a request transmitter 101, a response processor 102, a failure notification processor 103, an apparatus manager 104, and a path controller 105. Here, the apparatus controller 100, the request transmitter 101, the response processor 102, the failure notification processor 103, the apparatus manager 104, and the path controller 105 may be circuits composed of hardware such, for example, as field-programmable gate arrays (FPGA) or ASICs.

The apparatus controller 100 controls operations of the upper layer 3 switch 1. The apparatus controller 100 issues various kinds of instructions to the request transmitter 101, the response processor 102, the failure notification processor 103, the apparatus manager 104, and the path controller 105 according to predetermined algorithm.

The request transmitter 101 transmits a multicast packet requesting a response to the lower layer 3 switches 3a and 3b. For example, the request transmitter 101 generates a multicast packet containing a request message requesting a response to the lower layer 3 switches 3a and 3b and outputs the multicast packet to the SW chip 14 via the bus 19. The SW chip 14 outputs the multicast packet to all the ports 16.

The request transmitter 101 repetitively transmits multiple multicast packets at time intervals specified by the timer information 134. The time interval is set, for example, based on a volume of packets in the network between the upper layer 3 switch 1 and the lower layer 3 switches 3a and 3b such that a packet congestion may be avoided. The request transmitter 101 is a transmitter.

According to an instruction from the apparatus controller 100, the response processor 102 determines whether a response is received from each of the lower layer 3 switches 3a and 3b every time a multicast packet is transmitted. The lower layer 3 switches 3a and 3b each transmit, for example, a response packet containing a response message to the request message to the upper layer 3 switch 1.

The response processor 102 receives the response packet from the SW chip 14 via the bus 19. The response processor 102 registers the lower layer 3 switch 3a or 3b with the response in the address list 132, and deletes the lower layer 3 switch 3a or 3b with no response from the address list 132. The response processor 102 is an example of a determination unit.

The failure notification processor 103 receives a failure notification of the forward path for the monitoring control packet from the lower layer 3 switch 3a or 3b. When the lower layer 3 switch 3a or 3b detects a failure in the forward path, the lower layer 3 switch 3a or 3b transmits, for example, a notification packet containing a failure notification message to the upper layer 3 switch 1.

The failure notification processor 103 receives the notification packet from the SW chip 14 via the bus 19. The failure notification processor 103 deletes, from the address list 132, the lower layer 3 switch 3a or 3b from which the failure notification is received. The apparatus controller 100 notifies the apparatus manager 104 of the update of the address list 132.

The apparatus manager 104 manages the apparatus management table 133 according to an instruction from the apparatus controller 100. When notified of the update of the address list 132 by the apparatus controller 100, the apparatus manager 104 creates update information indicating a change from response reception to non-reception or vice versa from the lower layer 3 switch 3a or 3b according to the update notification, and outputs the update information to the apparatus controller 100.

The apparatus manager 104 updates the apparatus management table 133 according to a change from response reception to non-reception or vice versa or a failure notification message from the lower layer 3 switch 3a or 3b. The apparatus manager 104 is an example of an update unit.

Based on updated data made in the apparatus management table 133, the path controller 105 switches the forwarding destination of the monitoring control packet addressed to the ring network 90 between the lower layer 3 switches 3a and 3b to which the switching hub 2 is coupled, for example, switches the forwarding destination from the lower layer 3 switch 3a or 3b with no response to the lower layer 3 switch 3a or 3b with a response. Thus, the upper layer 3 switch 1 is able to forward the monitoring control packet to the lower layer 3 switch 3a or 3b having no failure in the forward path from the upper layer 3 switch 1.

For example, the path controller 105 receives the update notification of the apparatus management table 133 from the apparatus controller 100, and then refers to the updated data in the apparatus management table 133. According to the updated data, the path controller 105 updates the IP address of the lower layer 3 switch 3a or the lower layer 3 switch 3b which is registered as the static routing path in the routing table 131, thereby switching the forward path for the monitoring control packet addressed to the ring network 90.

The path controller 105 rewrites the IP address registered as the static routing path in the routing table 131 according to the updated data in the apparatus management table 133. For example, the path controller 105 switches the forwarding destination of the monitoring control packet according to the updated data in the apparatus management table 133 depending on a change in the result of a determination on whether a response is from each of the lower layer 3 switches 3a and 3b.

The SW chip 14 forwards the monitoring control packet to the destination port 16 based on the routing table 131. Thus, the upper layer 3 switch 1 is able to switch the forward path for the monitoring control packet addressed to the ring network 90 according to a change in the statuses of the forward paths between the upper layer 3 switch 1 and the respective lower layer 3 switches 3a and 3b.

Next, a configuration of the lower layer 3 switch 3a or 3b is described.

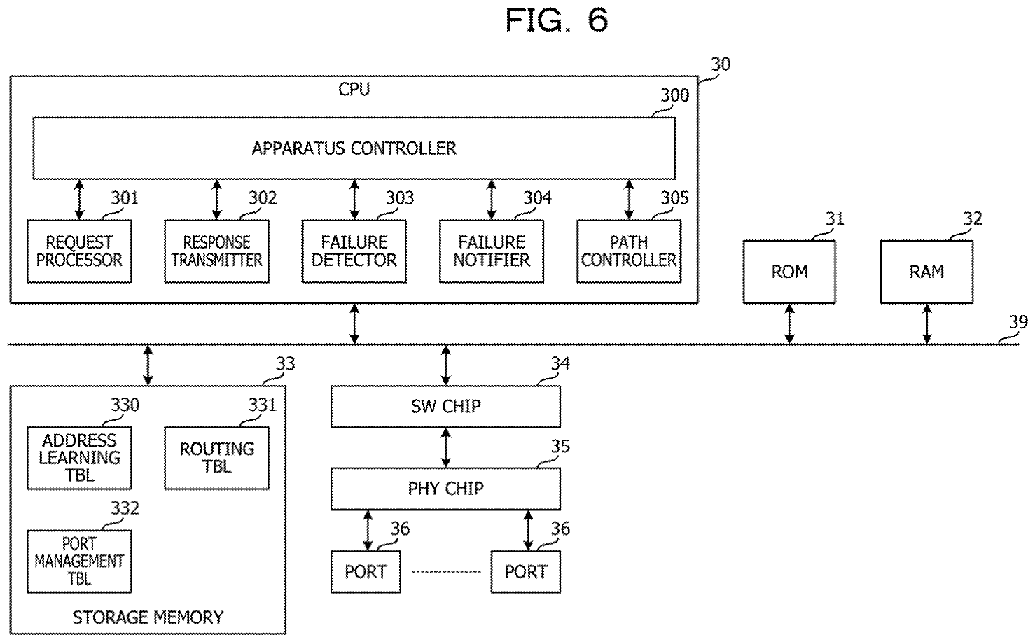

FIG. 6 is a configuration diagram illustrating an example of the lower layer 3 switch 3a or 3b. The lower layer 3 switch 3a or 3b includes a CPU 30, a ROM 31, a RAM 32, a storage memory 33, a SW chip 34, a PHY chip 35, and multiple ports 36. The CPU 30 is coupled to the ROM 31, the RAM 32, the storage memory 33, the SW chip 34, and the multiple ports 36 via a bus 39 in a manner capable of inputting and outputting signals to and from them.

The ROM 31 stores therein a program for driving the CPU 30. The RAM 32 functions as a working memory for the CPU 30.

The ports 36 transmit and receive various kinds of packets to and from other apparatuses. Each of the ports 36 includes, for example, a laser diode and a modulator for transmitting packets, a photo diode and a demodulator for receiving packets, and so on. Each of the ports 36 forwards packets such as a monitoring control packet and a multicast packet. Some of the ports 36 serve as the above ports b to e.

The PHY chip 35 is composed of hardware such, for example, as an ASIC. The PHY chip 35 is coupled to all the ports 36, and inputs and outputs packets to and from the ports 36. The PHY chip 35 processes a physical layer of a packet transmitted or received by each port 36.

The SW chip 34 is composed of hardware such, for example, as an ASIC. The SW chip 34 is coupled to all the ports 36 via the PHY chip 35, and exchanges packets between the ports 36. The SW chip 34 identifies the destination of a packet outputted from each port 36 and outputs the packet to the port 36 specified by the destination.

The storage memory 33 stores therein an address learning table (TBL) 330, a routing table (TBL) 331, and a port management table (TBL) 332. The address learning table 330 is managed by the SW chip 34, and is referred to by the SW chip 34 in packet forwarding with a layer 2 function.

The routing table 331 and the port management table 332 are managed by the CPU 30. The SW chip 34 forwards the monitoring control packet to another one of the lower layer 3 switches 3a to 3c in the ring network 90 based on the routing table 331. The port management table 332 registers whether there is a failure in the forward path for each port 36.

The CPU 30 loads the program from the ROM 31, and forms functions of an apparatus controller 300, a request processor 301, a response transmitter 302, a failure detector 303, a failure notifier 304, and a path controller 305. Here, the apparatus controller 300, the request processor 301, the response transmitter 302, the failure detector 303, the failure notifier 304, and the path controller 305 may be circuits composed of hardware such, for example, FPGAs or ASICs.

The apparatus controller 300 controls operations of the lower layer 3 switch 3a or 3b. The apparatus controller 300 issues various kinds of instructions to the request processor 301, the response transmitter 302, the failure detector 303, the failure notifier 304, and the path controller 305 according to predetermined sequences.

The request processor 301 obtains a request message from the multicast packet received from the upper layer 3 switch 1. The SW chip 34 identifies the multicast packet among packets received at the ports 36 and outputs the multicast packet to the request processor 301 via the bus 39. The request processor 301 notifies the apparatus controller 300 of the obtaining of the request message.

The response transmitter 302 creates and transmits a response packet containing a response message to the request message according to an instruction from the apparatus controller 300. For example, the response transmitter 302 transmits a response in response to the reception of the multicast packet containing the request message. The response transmitter 302 outputs the response packet to the SW chip 34 via the bus 39. The response packet is inputted to one of the ports 36 from the SW chip 34 and transmitted from the port 36 to the upper layer 3 switch 1.

The failure detector 303 detects a failure in the forward path of each port 36. The PHY chip 35 monitors the communication status of each port 36, and thereby collects failure information on a failure. The SW chip 34 outputs the failure information to the failure detector 303 via the bus 39. The failure detector 303 detects a failure based on the failure information and registers the failure for each part 36 into the port management table 332. The failure detector 303 notifies the apparatus controller 300 of the occurrence of the failure.

The failure notifier 304 notifies the upper layer 3 switch 1 of the failure in the forward path for the monitoring control packet according to an instruction from the apparatus controller 300. For example, the failure notifier 304 creates a notification packet containing a failure notification message based on the port management table 332. The failure notifier 304 outputs the notification packet to the SW chip 34 via the bus 39. The notification packet is inputted to one of the ports 36 from the SW chip 34, and is transmitted to the upper layer 3 switch 1 from the port 36.

When a failure occurs in the forward path, the path controller 05 switches the forward path according to an instruction from the apparatus controller 300 in accordance with routing protocol such as OSPF. In this process, the path controller 305 updates the routing table 331.

Next, description is given of an example of communications among the network monitoring control apparatus 9, the upper layer 3 switch 1, and the lower layer 3 switches 3a to 3c.

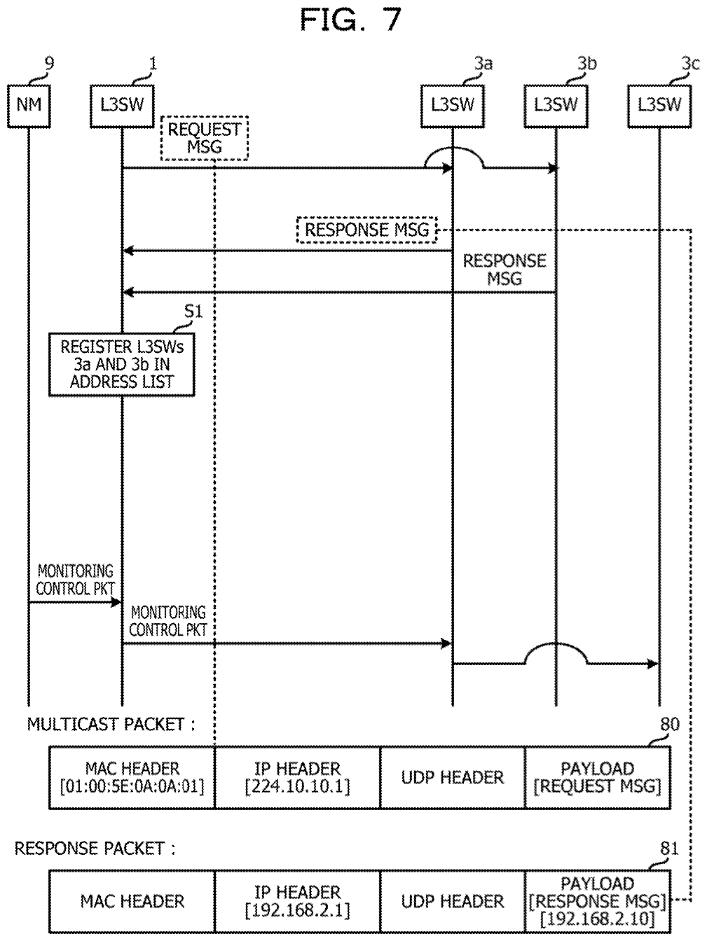

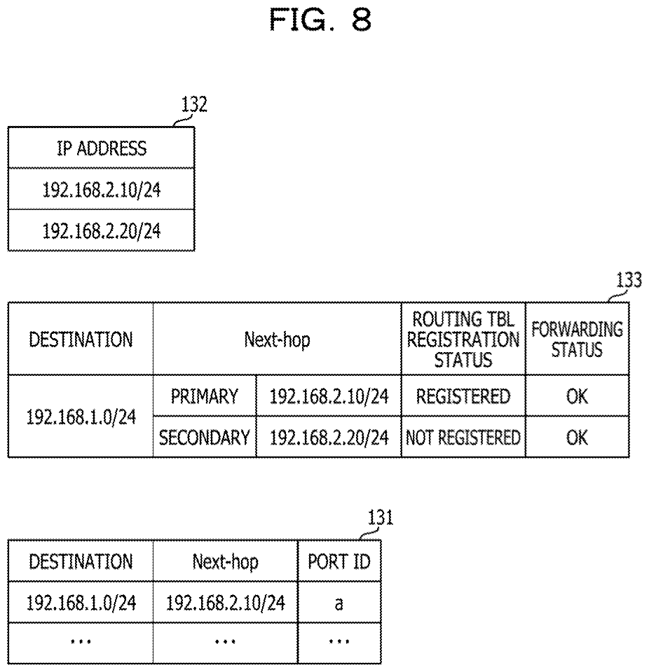

FIG. 7 is a sequence diagram illustrating an example of communications in the case where no failure occurs. FIG. 8 is a diagram illustrating an example of the address list 132, the apparatus management table 133, and the routing table 131 in the case where no failure occurs.

Referring to FIG. 8 first, the routing table 131 registers a destination, a next-hop, and a port ID as a static routing path. In the destination, registered is “192.168.1.0/24” that is the address of the ring network 90 to which the monitoring control packet is to be transmitted. In the next-hop, registered is “192.1682.10/24” that is the IP address of the lower layer 3 switch 3a to which the monitoring control packet is to be forwarded. In the port ID, registered is “a” that is the ID of the port a which is a transmission source of the monitoring control packet among the ports 16.

The apparatus management table 133 registers a destination, a next-hop, a routing table registration status, and a forwarding status. In the destination, registered is “192.168.1.0/24” that is the address of the ring network 90 to which the monitoring control packet is to be transmitted.

In the next-hop, registered are the IP addresses of a primary and a secondary as candidates for the forwarding destination. The IP address “192.168.2.10/24” of the lower layer 3 switch 3a which is one of the lower layer 3 switches 3a and 3b is registered in the primary of the next-hop, and the IP address “192.168.2.20/24” of the other lower layer 3 switch 3b is registered in the secondary of the next-hop.

The routing table registration status is information indicating whether the IP address of each of the primary and the secondary in the next-hop is registered in the routing table 131. In the present example, since the IP address of the lower layer 3 switch 3a is registered in the routing table 131, the routing table registration status of the IP address of the primary indicates “registered” and the routing table registration status of the IP address of the secondary indicates “not registered”

The forwarding status is information indicating whether each of the lower layer 3 switches 3a and 3b of the primary and the secondary is currently able to forward the monitoring control packet, and the forwarding statuses of the lower layer 3 switches 3a and 3b are set to “OK” (forwarding is available). The forwarding status of the lower layer 3 switch 3a or 3b from which a response is received is set to “OK” (forwarding is available) and the forwarding status of the lower layer 3 switch 3a or 3b from which no response or a failure notification is received is set to “NA” (forwarding is unavailable).

Referring to FIG. 7, the upper layer 3 switch 1 transmits a multicast packet containing a request message (MSG) requesting a response to the lower layer 3 switches 3a and 3b.

Reference sign 80 illustrates an example of the format of a multicast packet containing a request message. The multicast packet contains a media access control (MAC) header, an IP header, a user datagram protocol (UDP) header, and a payload.

The MAC header contains a multicast MAC address (for example, “01:00:5E:0A:0A:01”) as a destination address (DA) to which the multicast packet is to be transmitted. The IP header contains a class D multicast IP address (for example, “224.10.10.1”) as a destination IP address. The switching hub 2 identifies the multicast packet based on the multicast MAC address, copies the multicast packet, and forward the multicast packets to the respective lower layer 3 switches 3a and 3b. The payload contains a predetermined identifier representing the request message. Each of the lower layer 3 switches 3a and 3b identifies the request message based on the identifier.

In response to the reception of the request message, the request transmitter 101 in each of the lower layer 3 switches 3a and 3b creates a response packet containing a response message (MSG) and transmits the response packet to the upper layer 3 switch 1. In an example, it is assumed that the lower layer 3 switch 3a transmits the response message before the other lower layer 3 switch 3b transmits the response message.

Reference sign 81 illustrates an example of the format of a response packet containing a response message. The response packet contains a MAC header, an IP header, a UDP header, and a payload.

The MAC header contains the MAC address of the upper layer 3 switch 1 as a destination address (DA) to which the response packet is to be transmitted. The IP header contains the IP address of the upper layer 3 switch 1 (“192.168.2.1” in the present example) as a destination IP address. The payload contains a predetermined identifier representing the response message and the IP address of the lower layer 3 switch 3a or 3b (“192.168.2.10” in the case of the lower layer 3 switch 3a). The upper layer 3 switch 1 identifies the response message based on the identifier. The response packet may be configured as a multicast packet containing the response message.

The response processor 102 of the upper layer 3 switch 1 receives the response message from each of the lower layer 3 switches 3a and 3b. The response processor 102 registers into the address list 132 the IP addresses (“192.168.2.10/24” and “192.168.2.20/24”) of the ports b and c of the lower layer 3 switches 3a and 3b with the responses (reference sign S1). The apparatus manager 104 creates the update information when the address list 132 is updated.

The network monitoring control apparatus (NM) 9 transmits a monitoring control packet addressed to the lower layer 3 switch 3c to the upper layer 3 switch 1. The SW chip 14 of the upper layer 3 switch 1 forwards the monitoring control packet to the lower layer 3 switch 3a according to the routing table 131. The forwarding destination of the monitoring control packet may be the other lower layer 3 switch 3b instead of the lower layer 3 switch 3a.

The SW chip 34 of the lower layer 3 switch 3a forwards the monitoring control packet to the lower layer 3 switch 3c in accordance with OSPF. Thus, the monitoring control packet addressed to the ring network 90 may be forwarded from the network monitoring control apparatus 9 to the lower layer 3 switches 3a to 3c in the ring network 90.

Next, description is given of an example of communications in the case where a failure occurs after the communications in the present example.

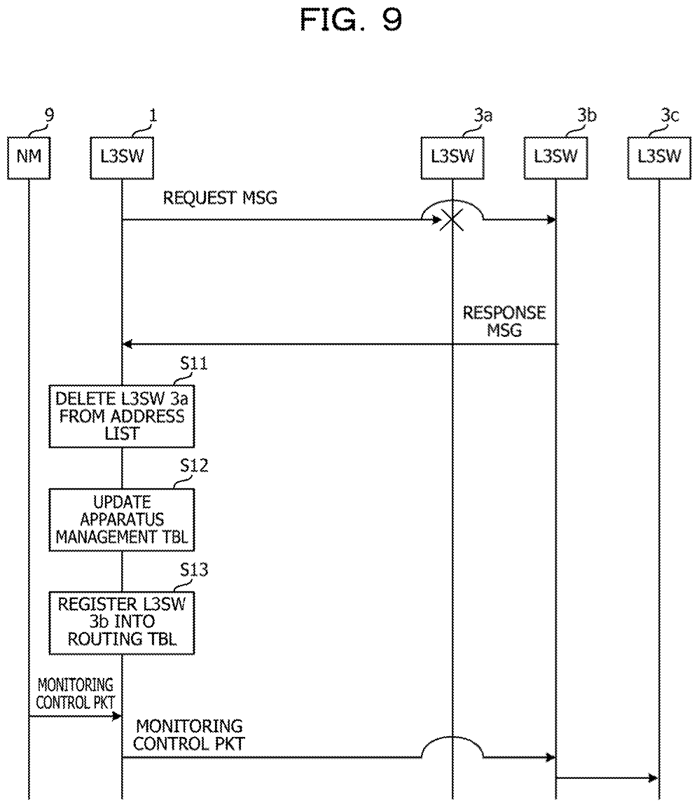

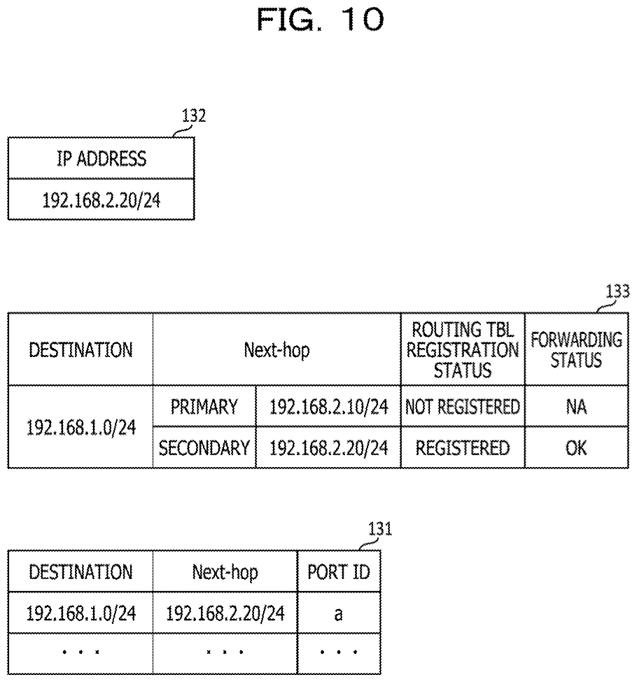

FIG. 9 is a sequence diagram illustrating an example of communications in the case where a failure occurs in the forward path between the upper layer 3 switch 1 and the forwarding destination lower layer 3 switch 3a. FIG. 10 is a diagram illustrating an example of the address list 132, the apparatus management table 133, and the routing table 131 in the case where a failure occurs in the forward path between the upper layer 3 switch 1 and the forwarding destination lower layer 3 switch 3a.

The request transmitter 101 of the upper layer 3 switch 1 transmits a multicast packet containing a request message to both of the lower layer 3 switches 3a and 3b. In this operation, the request transmitter 101 transmits a single multicast packet and the switching hub 2, not illustrated, copies the multicast packet and forwards the multicast packets to the respective lower layer 3 switches 3a and 3b.

However, due to the occurrence of the failure in the forward path between the upper layer 3 switch 1 and the forwarding destination lower layer 3 switch 3a, the lower layer 3 switch 3a fails to receive the request message (see a cross sign). For this reason, the lower layer 3 switch 3a fails to transmit a response message. On the other hand, the other lower layer 3 switch 3b is able to transmit a response message because no failure occurs in the forward path from the upper layer 3 switch 1.

The response processor 102 of the upper layer 3 switch 1 determines that there is no response from the lower layer 3 switch 3a because a response message is not received from the lower layer 3 switch 3a, for example, within a predetermined period of time. For this reason, the response processor 102 deletes the IP address of the lower layer 3 switch 3a with no response from the address list 132 (reference sign S11). Along with this operation, according to the update of the address list 132, the apparatus manager 104 creates the update information indicating that there is no response from the lower layer 3 switch 3a.

The apparatus manager 104 updates the apparatus management table 133 based on the update information (reference sign S12). In this update, the apparatus manager 104 changes the forwarding status of the primary to “NA” because there is no response from the lower layer 3 switch 3a.

Based on the updated data in the apparatus management table 133, the path controller 105 registers the IP address “192.168.2.20/24” of the secondary lower layer 3 switch 3b with the response into the routing table 131 in place of the lower layer 3 switch 3a with no response (reference sign 513). Thus, the forwarding destination of the monitoring control packet is switched from the lower layer 3 switch 3a with no response to the lower layer 3 switch 3b with the response. In this operation, the apparatus manager 104 changes the routing table registration status of the primary to “not registered” according to the switching of the forwarding destination.

The network monitoring control apparatus 9 transmits a monitoring control packet addressed to the lower layer 3 switch 3c to the upper layer 3 switch 1. The SW chip 14 of the upper layer 3 switch 1 forwards the monitoring control packet to the lower layer 3 switch 3b according to the routing table 131.

The lower layer 3 switch 3b forwards the monitoring control packet to the lower layer 3 switch 3c in accordance with OSPF. Thus, the monitoring control packet addressed to the ring network 90 may be forwarded from the network monitoring control apparatus 9 to the lower layer 3 switches 3a to 3c in the ring network 90.

In this way, the request transmitter 101 transmits a multicast packet requesting a response to the lower layer 3 switches 3a and 3b to the lower layer 3 switches 3a and 3b. The response processor 102 determines whether a response is received from each of the lower layer 3 switches 3a and 3b.

The apparatus manager 104 updates the apparatus management table 133 according to a result of the determination on whether the responses are received. Based on the updated data in the apparatus management table 133, the path controller 105 switches the forwarding destination of the monitoring control packet addressed to the ring network 90 from the lower layer 3 switch 3a with no response to the lower layer 3 switch 3b with the response.

Thus, the upper layer 3 switch 1 does not have to separately set and transmit the echo requests R1q and R2q to the respective lower layer 3 switches 3a and 3b, but is able to determine whether the forwarding of a monitoring control packet to each of the lower layer 3 switches 3a and 3b is available by transmitting a single multicast packet. This reduces the burden of the processing in the upper layer 3 switch 1 more as the network scale becomes larger, and a reduction in the number of packets also leads to a reduced burden of the layer 2 network 91.

In reverse to the present example, also in the case where the forwarding destination of a monitoring control packet is the lower layer 3 switch 3b and a failure occurs in the forward path between the upper layer 3 switch 1 and the lower layer 3 switch 3b, the switching of the forwarding destination is performed in the same manner as in the above.

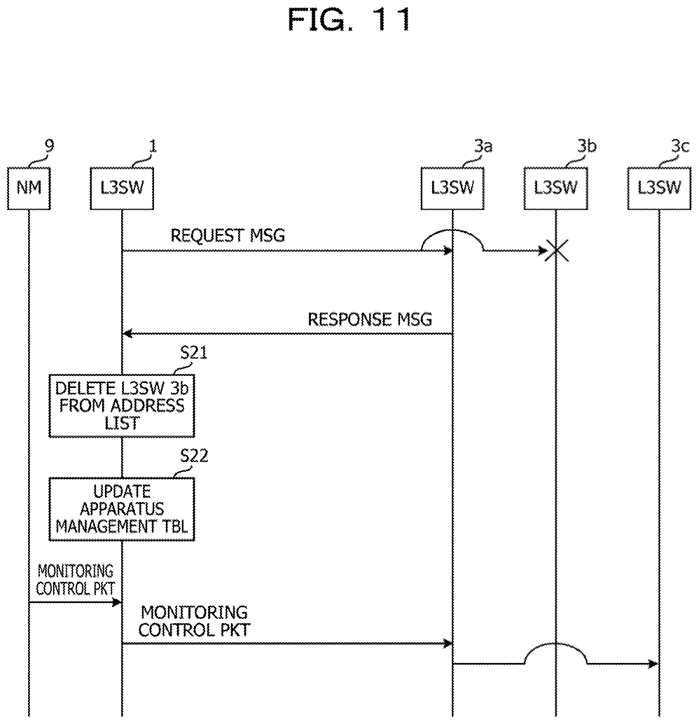

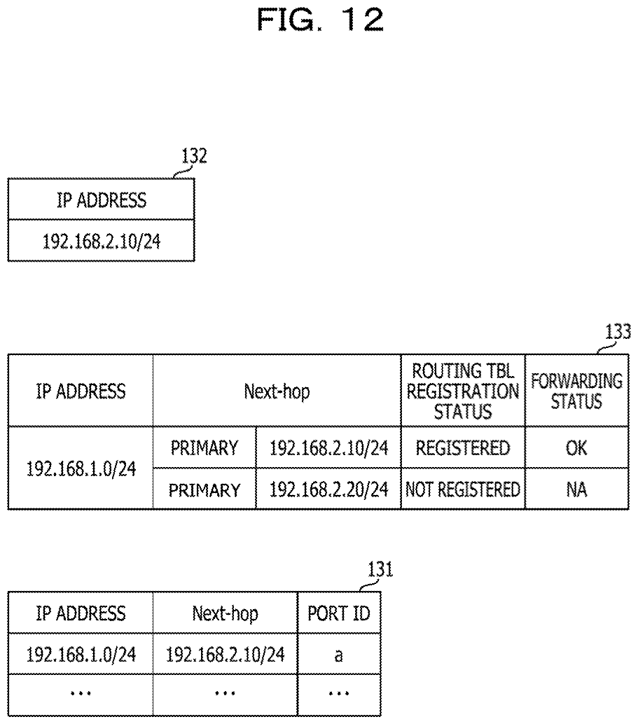

FIG. 11 is a sequence diagram illustrating an example in the case where a failure occurs in the forward path between the upper layer 3 switch 1 and the non-forwarding destination lower layer 3 switch 3b. FIG. 12 is a diagram illustrating an example of the address list 132, the apparatus management table 133, and the routing table 131 after communications in the case where a failure occurs in the forward path between the upper layer 3 switch 1 and the non-forwarding destination lower layer 3 switch 3b.

The request transmitter 101 of the upper layer 3 switch 1 transmits a multicast packet containing a request message to both of the lower layer 3 switches 3a and 3b.

However, due to the occurrence of the failure in the forward path between the upper layer 3 switch 1 and the non-forwarding destination lower layer 3 switch 3b, the lower layer 3 switch 3b fails to receive the request message (see a cross sign). For this reason, the lower layer 3 switch 3b fails to transmit a response message. On the other hand, the forwarding destination lower layer 3 switch 3a is able to transmit a response message because no failure occurs in the forward path from the upper layer 3 switch 1.

The response processor 102 of the upper layer 3 switch 1 determines that there is no response from the lower layer 3 switch 3b because a response message is not received from the lower layer 3 switch 3b, for example, within a predetermined period of time. For this reason, the response processor 102 deletes the IP address of the lower layer 3 switch 3b with no response from the address list 132 (reference sign S21). Along with this operation, according to the update of the address list 132, the apparatus manager 104 creates the update information indicating that there is no response from the lower layer 3 switch 3b.

The apparatus manager 104 updates the apparatus management table 133 based on the update information (reference sign S22). In this update, the apparatus manager 104 changes the forwarding status of the secondary to “NA” because there is no response from the lower layer 3 switch 3b.

Even when there is no response from the lower layer 3 switch 3b, the path controller 105 refers to the updated data in the apparatus management table 133 and thereby is able to determine that the response from the lower layer 3 switch 3a whose IP address is registered in the routing table 131 keeps coming. For this reason, the path controller 105 does not update the routing table 131.

The network monitoring control apparatus 9 transmits a monitoring control packet addressed to the lower layer 3 switch 3c to the upper layer 3 switch 1. The SW chip 14 of the upper layer 3 switch 1 forwards the monitoring control packet to the lower layer 3 switch 3a according to the routing table 131.

In this way, in the case where the failure occurs in the forward path between the upper layer 3 switch 1 and the lower layer 3 switch 3b that is not the forwarding destination of the monitoring control packet addressed to the ring network 90, the address list 132 and the apparatus management table 133 are updated but the routing table 131 is not updated. For this reason, the forwarding destination of the monitoring control packet is not switched.

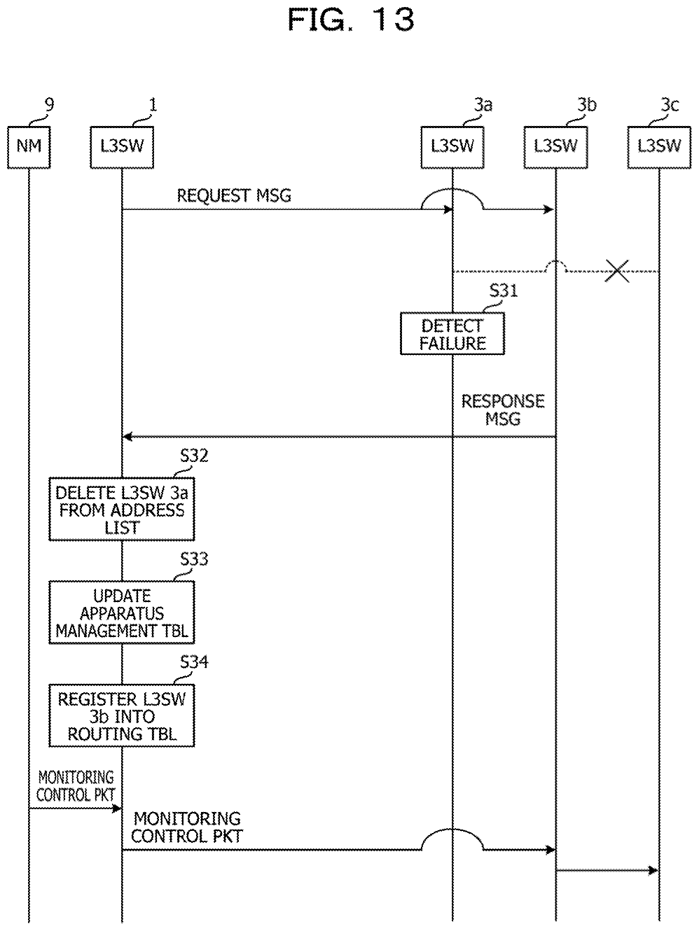

FIG. 13 is a sequence diagram illustrating an example of communications in the case where a failure occurs in the forward path between the lower layer 3 switch 3a and the lower layer 3 switch 3c at the next node in the ring network 90. The address list 132, the apparatus management table 133, and the routing table 131 in the present example are the same as illustrated in FIG. 10.

The request transmitter 101 of the upper layer 3 switch 1 transmits a multicast packet containing a request message to both of the lower layer 3 switches 3a and 3b. The failure detector 303 of the forwarding destination lower layer 3 switch 3a detects a failure in the forward path to the lower layer 3 switch 3c at the next node (see a cross sign) (reference sign 531).

In this case, the response transmitter 302 of the lower layer 3 switch 3a suspends transmission of a response message for a period when the failure is detected. Since the other lower layer 3 switch 3b does not detect a failure, the lower layer 3 switch 3b transmits a response message to the upper layer 3 switch 1 in response to the reception of the request message.

The response processor 102 of the upper layer 3 switch 1 determines that there is no response from the lower layer 3 switch 3a because a response message is not received from the lower layer 3 switch 3a, for example, within a predetermined period of time. For this reason, the response processor 102 deletes the IP address of the lower layer 3 switch 3a with no response from the address list 132 (reference sign S32). Along with this operation, according to the update of the address list 132, the apparatus manager 104 creates the update information indicating that there is no response from the lower layer 3 switch 3a.

The apparatus manager 104 updates the apparatus management table 133 based on the update information (reference sign 533). In this update, the apparatus manager 104 changes the forwarding status of the primary to “NA” because there is no response from the lower layer 3 switch 3a.

Based on the updated data in the apparatus management table 133, the path controller 105 registers the IP address “192.168.2.20/24” of the secondary lower layer 3 switch 3b with the response into the routing table 131 in place of the lower layer 3 switch 3a with no response (reference sign S34). Thus, the forwarding destination of the monitoring control packet is switched from the lower layer 3 switch 3a with no response to the lower layer 3 switch 3b with the response. In this operation, the apparatus manager 104 changes the routing table registration status of the primary to “not registered” according to the switching of the forwarding destination.

The network monitoring control apparatus 9 transmits a monitoring control packet addressed to the lower layer 3 switch 3c to the upper layer 3 switch 1. The SW chip 14 of the upper layer 3 switch 1 forwards the monitoring control packet to the lower layer 3 switch 3b according to the routing table 131.

The SW chip 34 of the lower layer 3 switch 3b forwards the monitoring control packet to the lower layer 3 switch 3c in accordance with. OSPF. Thus, the monitoring control packet addressed to the ring network 90 may be forwarded from the network monitoring control apparatus 9 to the lower layer 3 switches 3a to 3c in the ring network 90.

As described above, in the case where a failure is detected in the forward path to the lower layer 3 switch 3c at the next node, the response transmitter 302 of the lower layer 3 switch 3a does not transmit a response message even when receiving a request message. Thus, as in the example illustrated in FIG. 9, the upper layer 3 switch 1 is able to switch the forwarding destination of the monitoring control packet addressed to the ring network 90 to the other lower layer 3 switch 3b according to the updated data in the apparatus management table 133.

However, even when a failure occurs as in the present example for a period when the upper layer 3 switch 1 does not transmit a request message or is not monitoring reception of a response message, the upper layer 3 switch 1 is unable to determine whether a response is received from each of the lower layer 3 switches 3a and 3b. For this reason, under the condition where each of the lower layer 3 switches 3a and 3b does not receive the request message, the lower layer 3 switch 3a or 3b transmits a failure notification to the upper layer 3 switch 1 as in the following example.

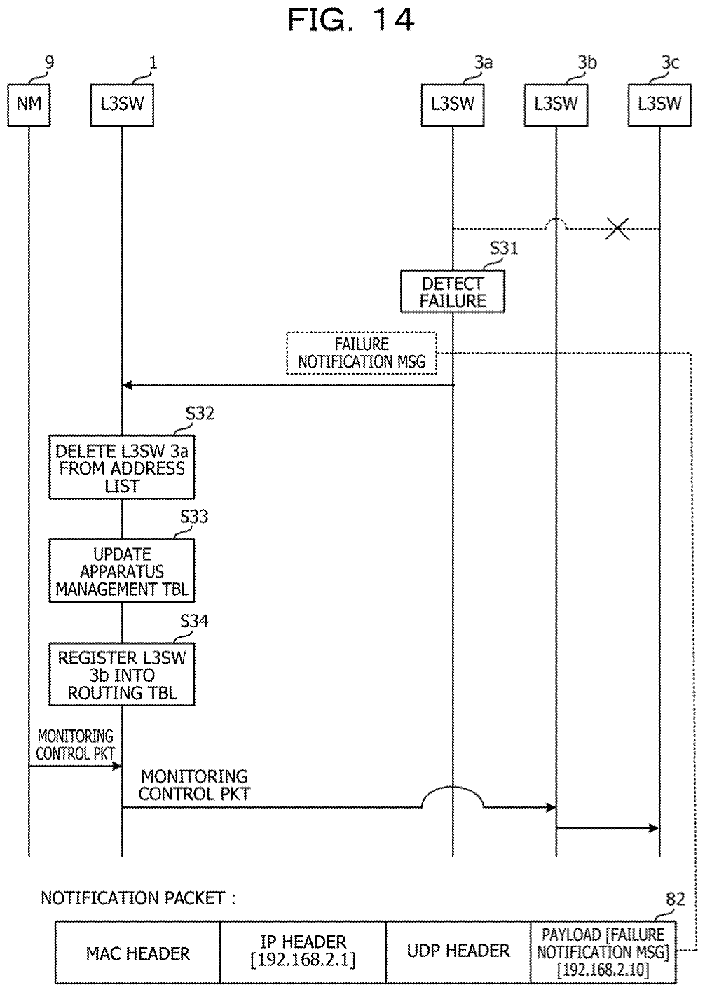

FIG. 14 is a sequence diagram illustrating another example of communications in the case where a failure occurs in the forward path between the lower layer 3 switch 3a and the lower layer 3 switch 3c at the next node in the ring network 90. The address list 132, the apparatus management table 133, and the routing table 131 in the present example are the same as illustrated in FIG. 10. In FIG. 14, processes in common with FIG. 13 are denoted by the same reference signs, and the explanation thereof is omitted.

In the present example, the upper layer 3 switch 1 does not transmit a request message. When a failure is detected in the forward path to the lower layer 3 switch 3c at the next node (reference sign S31) under the condition where a request message is not received, the failure notifier 304 of the lower layer 3 switch 3a creates a notification packet containing a failure notification message and transmits the notification packet to the upper layer 3 switch 1.

Reference sign 82 illustrates an example of the format of a notification packet containing a failure notification message. The notification packet contains a MAC header, an IP header, a UDP header, and a payload.

The MAC header contains the MAC address of the upper layer 3 switch 1 as a DA to which the notification packet is to be transmitted. The IP header contains the IP address of the upper layer 3 switch 1 (“192.168.2.1” in the present example) as a destination IP address. The payload contains a predetermined identifier representing the failure notification message and the IP address of the lower layer 3 switch 3a or 3b (“192.168.2.10” in the case of the lower layer 3 switch 3a). The upper layer 3 switch 1 identifies the failure notification message based on the identifier. The notification packet may be configured as a multicast packet containing the failure notification message.

In response to the reception of the failure notification message, the failure notification processor 103 deletes from the address list 132 the IP address of the lower layer 3 switch 3a which is a sender of the failure notification message (reference sign S32). Along with this operation, according to the update of the address list 132, the apparatus manager 104 creates the update information indicating that there is no response from the lower layer 3 switch 3a.

The apparatus manager 104 updates the apparatus management table 133 based on the update information (reference sign S33). The apparatus manager 104 changes the forwarding status of the primary to “NA” because there is no response from the lower layer 3 switch 3a.

Based on the update information of the apparatus management table 133, the path controller 105 registers the IP address “192.168.2.20/24” of the secondary lower layer 3 switch 3b into the routing table 131 in place of the lower layer 3 switch 3a with no response (reference sign S34). Thus, the upper layer 3 switch 1 is able to switch the forwarding destination to the other lower layer 3 switch 3b as in the example in FIG. 9. In this operation, the apparatus manager 104 changes the routing table registration status of the primary to “not registered” according to the switching of the forwarding destination.

As described above, when the lower layer 3 switch 3a, which is the forwarding destination of the monitoring control packet addressed to the ring network 90, makes a notification of the occurrence of a failure in the forward path to the lower layer 3 switch 3c at the next node in the ring network 90, the path controller 105 switches the forwarding destination of the monitoring control packet addressed to the ring network 90 to the lower layer 3 switch 3b. Thus, even for a period when a multicast packet is not transmitted, the upper layer 3 switch 1 is able to quickly switch the forwarding destination in response to the occurrence of a failure in the forward path in the ring network 90.

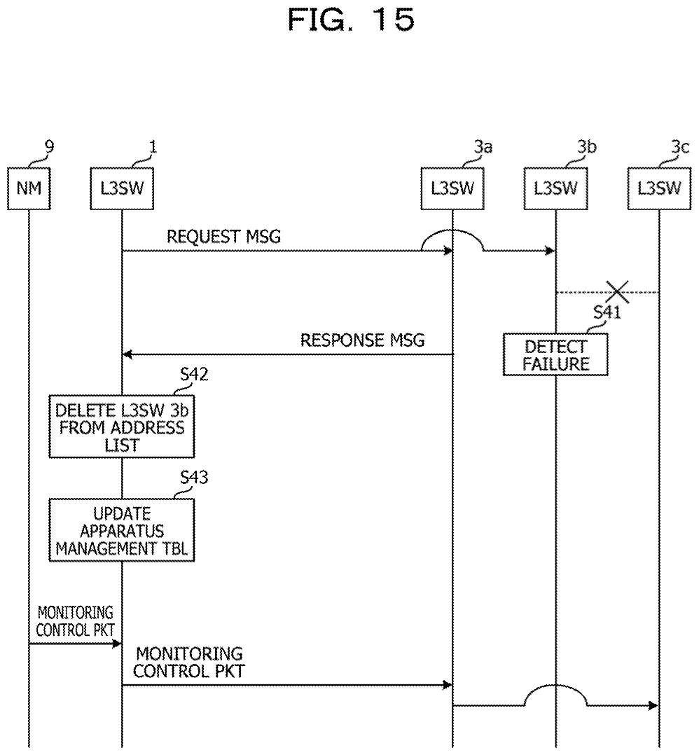

FIG. 15 is a sequence diagram illustrating an example of communications in the case where a failure occurs in the forward path between the non-forwarding destination lower layer 3 switch 3b and the lower layer 3 switch 3c at the next node. The address list 132, the apparatus management table 133, and the routing table 131 in the present example are the same as illustrated in FIG. 12.

The request transmitter 101 of the upper layer 3 switch 1 transmits a multicast packet containing a request message to both of the lower layer 3 switches 3a and 3b. The failure detector 303 of the non-forwarding destination lower layer 3 switch 3b detects a failure in the forward path to the lower layer 3 switch 3c at the next node (see a cross sign) (reference sign S41).

For this reason, the response transmitter 302 of the lower layer 3 switch 3b suspends transmission of a response message for a period when the failure is detected. Since the other lower layer 3 switch 3a does not detect a failure, the lower layer 3 switch 3a transmits a response message to the upper layer 3 switch 1 in response to the reception of the request message.

The response processor 102 of the upper layer 3 switch 1 determines that there is no response from the lower layer 3 switch 3b because a response message is not received from the lower layer 3 switch 3b, for example, within a predetermined period of time. For this reason, the response processor 102 deletes the IP address of the lower layer 3 switch 3b with no response from the address list 132 (reference sign S42). Along with this operation, according to the update of the address list 132, the apparatus manager 104 creates the update information indicating that there is no response from the lower layer 3 switch 3b.

The apparatus manager 104 updates the apparatus management table 133 based on the update information (reference sign S43). The apparatus manager 104 changes the forwarding status of the secondary to “NA” because there is no response from the lower layer 3 switch 3b.

Even when there is no response from the lower layer 3 switch 3b, the path controller 105 refers to the updated data in the apparatus management table 133 and thereby is able to determine that the response from the lower layer 3 switch 3a whose IP address is registered in the routing table 131 keeps coming. For this reason, the path controller 05 does not update the routing table 131.

The network monitoring control apparatus 9 transmits a monitoring control packet addressed to the lower layer 3 switch 3c to the upper layer 3 switch 1. The SW chip 14 of the upper layer 3 switch 1 forwards the monitoring control packet to the lower layer 3 switch 3a according to the routing table 131.

The lower layer 3 switch 3a forwards the monitoring control packet to the lower layer 3 switch 3c in accordance with OSPF. Thus, the monitoring control packet addressed to the ring network 90 may be forwarded from the network monitoring control apparatus 9 to the lower layer 3 switches 3a to 3c in the ring network 90.

As described above, in the case where a failure is detected in the forward path to the lower layer 3 switch 3c at the next node, the response transmitter 302 of the lower layer 3 switch 3b does not transmit a response message even when a request message is received. Thus, the upper layer 3 switch 1 determines that no response is received from the lower layer 3 switch 3b, and updates the forwarding status of the lower layer 3 switch 3b in the apparatus management table 133. However, since the routing table 131 is not updated, the forwarding destination of the monitoring control packet is not switched.

Under the condition where a request message is not received, the lower layer 3 switch 3b transmits a failure notification to the upper layer 3 switch 1 as in the following example.

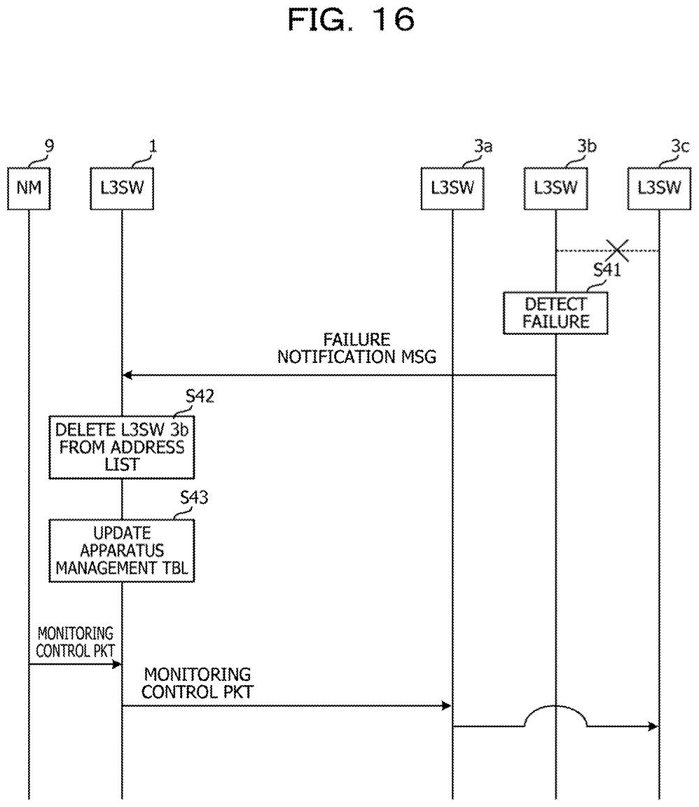

FIG. 16 is a sequence diagram illustrating another example of communications in the case where a failure occurs in the forward path between the lower layer 3 switch 3b, which is the non-forwarding destination of the monitoring control packet addressed to the ring network 90, and the lower layer 3 switch 3c at the next node. The address list 132, the apparatus management table 133, and the routing table 131 in the present example are the same as illustrated in FIG. 12. In FIG. 16, processes in common with FIG. 15 are denoted by the same reference signs, and the explanation thereof is omitted.

In the present example, the upper layer 3 switch 1 does not transmit a request message. When a failure is detected in the forward path to the lower layer 3 switch 3c at the next node (reference sign S41) under the condition where a request message is not received, the failure notifier 304 of the lower layer 3 switch 3b creates a notification packet containing a failure notification message and transmits the notification packet to the upper layer 3 switch 1.

In response to the reception of the failure notification message, the failure notification processor 103 deletes from the address list 132 the IP address of the lower layer 3 switch 3b which is a sender of the failure notification message (reference sign S42). Along with this operation, according to the update of the address list 132, the apparatus manager 104 creates the update information indicating that there is no response from the lower layer 3 switch 3b.

The apparatus manager 104 updates the apparatus management table 133 based on the update information (reference sign S43). In this update, the apparatus manager 104 changes the forwarding status of the secondary to “NA” because there is no response from the lower layer 3 switch 3b. Thus, the upper layer 3 switch 1 is able to update the apparatus management table 133 as in the example of FIG. 15.

In this way, in the case where the failure occurs in the forward path between the lower layer 3 switch 3b, which is not the forwarding destination of the monitoring control packet addressed to the ring network 90, and the lower layer 3 switch 3c at the next node, the address list 132 and the apparatus management table 133 are updated but the routing table 131 is not updated. For this reason, the forwarding destination of the monitoring control packet is not switched.

Next, operations of the upper layer 3 switch 1 are described. Here, the operations of the upper layer 3 switch 1 are an example of a packet forwarding method.

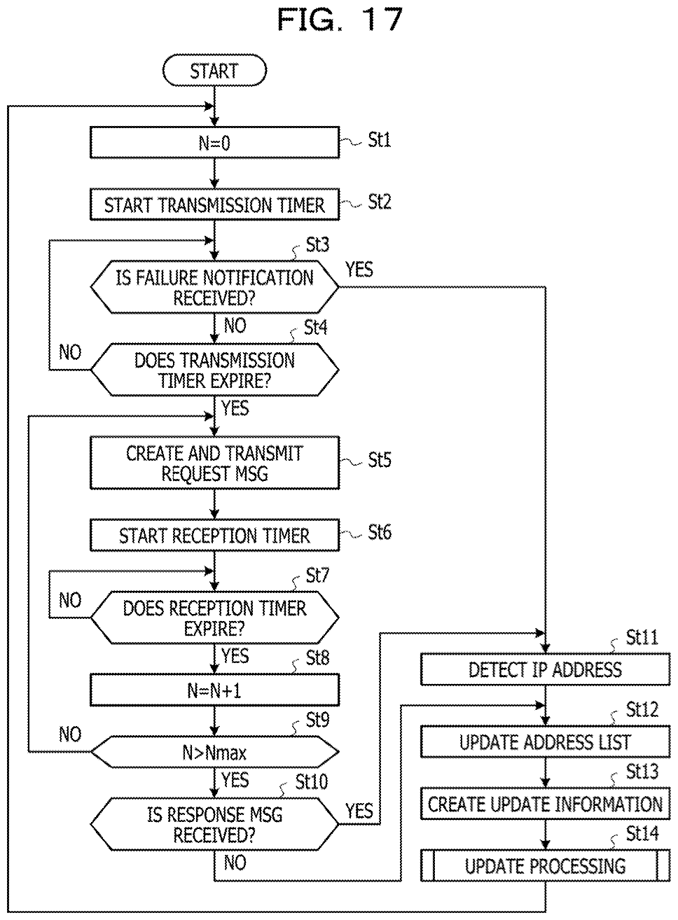

FIG. 17 is a flowchart illustrating an example of an operation of the upper layer 3 switch 1. The request transmitter 101 sets 0 in a transmission count N of a multicast packet containing a request message (step St1). Then, the response processor 102 starts the count of a transmission timer that measures a time interval between multicast packet transmissions (step St2).

Subsequently, the failure notification processor 103 determines whether a failure notification message is received from any of the lower layer 3 switches 3a and 3b (step St3). When a failure notification message is not received (No in step St3), the request transmitter 101 determines whether the transmission timer already expires (step St4). When the transmission timer does not expire yet (No in step St4), the process in step St3 is executed again. The request transmitter 101 sets in advance a time at which the transmission timer will expire to a value specified in the timer information 134.

When the transmission timer already expires (Yes in step St4), the request transmitter 101 creates a request message, and transmits a multicast packet with the request message inserted therein (step St5). Next, the response processor 102 starts the count of a reception timer for monitoring reception of a response message to the request message (step St6).

Subsequently, the response processor 102 determines whether reception timer already expires (step St7). When the reception timer does not expire yet (No in step St7), the process in step St7 is again executed. Here, the response processor 102 sets a time at which the reception timer will expire based on, for example, an average latency time in the layer 2 network 91 and a latency time in the lower layer 3 switches 3a and 3b.

When the reception timer already expires (Yes in step St7), the request transmitter 101 adds 1 to the transmission count N (step St8). Next, the request transmitter 101 compares the transmission count N with a maximum transmission count Nmax (step St9).

When the transmission count N is less than the maximum transmission count Nmax (No in step St9), the processes in step St5 and the following steps are executed again. When the transmission count N is equal to the maximum transmission count Nmax (Yes in step St9), the response processor 102 determines whether at least one response message is received (step St10).

When the response processor 102 receives at least one response message (Yes in step St10), the processes in step St11 and the following steps are executed. When the failure notification processor 103 receives a failure notification message (Yes in step St3), the processes in step St11 and the following steps are executed. Hereinafter, the processes in step St11 and the following steps are described.

The apparatus manager 104 detects the IP address of the lower layer 3 switch 3a or 3b from which the response message is received, or the failure notification processor 103 detects the IP address of the lower layer 3 switch 3a or 3b from which the failure notification message is received (step St11). The IP address is obtained from the payload in the response packet or the notification packet.

Next, the apparatus manager 104 or the failure notification processor 103 updates the address list 132 based on the detected IP address (step St12). For example, the apparatus manager 104 compares the IP address with the IP address in the address list 132, and updates the address list 132 according to the comparison result. When the IP address in the response message is not registered in the address list 132, the apparatus manager 104 registers the IP address into the address list 132. When the IP address in the failure notification message is registered in the address list 132, the failure notification processor 103 deletes the IP address from the address list 132.

When the IP addresses in the address list 132 include an IP address different from either of the IP addresses in the response message and the failure notification message, the apparatus manager 104 and the failure notification processor 103 delete the IP address from the address list 132. Thus, the address list 132 registers only the IP address of each of the lower layer 3 switches 3a and 3b having transmitted the response message.

When the response processor 102 does not receive even one response message (No in step St10), the processes in step St12 and the following steps are executed. In this case, since even one response message is not received, all the IP addresses in the address list 132 are deleted in step St12.

Next, the apparatus manager 104 creates the update information according to the update of the address list 132 made by the process in step St12 (step St13). The update information indicates an update from “no response” to “response” for the IP address registered in the address list 132 and an update from “response” to “no response” for the IP address deleted from the address list 132.

Then, the apparatus manager 104 and the path controller 105 execute update processing of the apparatus management table 133 and the routing table 131 (step St14). The update processing will be described later.

After that, the processes in step St1 and the following steps are executed. The upper layer 3 switch 1 operates in the above-described way.

In this way, the request transmitter 101 repeatedly transmits a multicast packet containing a request message at fixed time intervals, and the response processor 102 determines whether a response is received from each of the lower layer 3 switches 3a and 3b every time the multicast packet is transmitted.

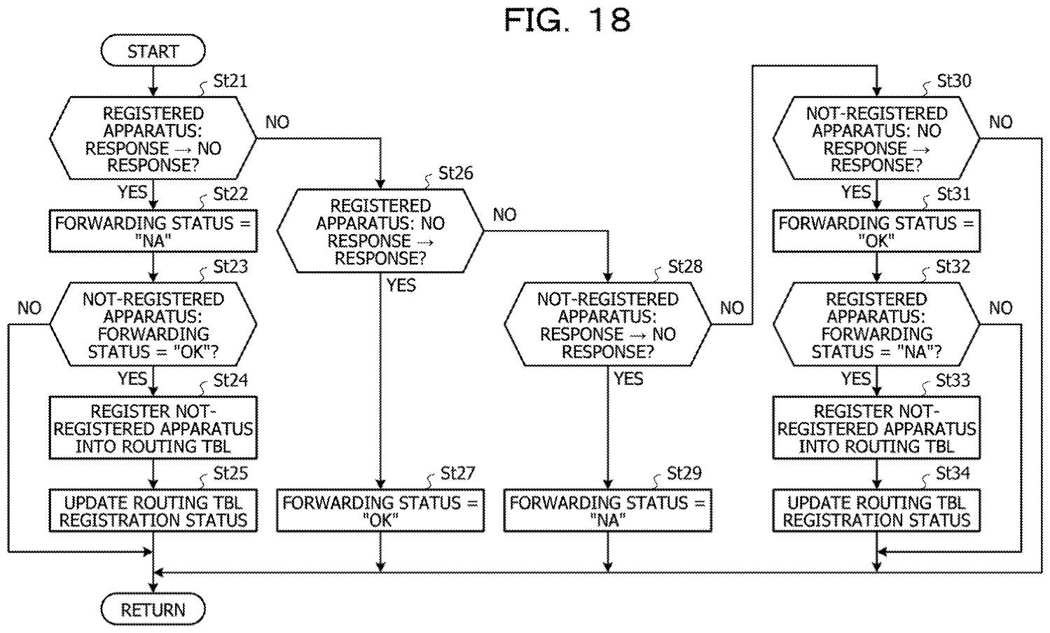

FIG. 18 is a flowchart illustrating an example of the update processing. The update processing is executed in step St15 presented in FIG. 17.

In FIG. 18, “registered apparatus” means the lower layer 3 switch 3a or the lower layer 3 switch 3b registered in the routing table 131 as the forwarding destination of the monitoring control packet addressed to the ring network 90. In the example of FIGS. 7 and 8, the registered apparatus is the lower layer 3 switch 3a of the primary. “not-registered apparatus” means the lower layer 3 switch 3a or the lower layer 3 switch 3b not registered in the routing table 131. In the example of FIGS. 7 and 8, the not-registered apparatus is the lower layer 3 switch 3b of the secondary.

In reference to the apparatus management table 133, the apparatus manager 104 recognizes the IP address whose routing table registration status is “registered” as the IP address of the “registered apparatus” and recognizes the IP address whose routing table registration status is “not registered” as the IP address of the “not-registered apparatus”.

The apparatus manager 104 determines whether the update information is information indicating an update from “response” to “no response” for the IP address of the registered apparatus (step St21). When the update information is the information indicating the update from “response” to “no response” (Yes in step St21), the apparatus manager 104 updates the forwarding status of the registered apparatus to “NA” in the apparatus management table 133 (step St22). Subsequently, the path controller 105 determines whether the forwarding status in the apparatus management table 133 is “OK” for the IP address of the not-registered apparatus (step St23).

When the forwarding status in the apparatus management table 133 is “OK” (Yes in step St23), the path controller 105 registers the IP address of the not-registered apparatus into the routing table 131 (step St24). Along with this operation, the IP address of the registered apparatus is deleted from the routing table 131. Thus, the path controller 105 switches the forwarding destination of the monitoring control packet from the lower layer 3 switch 3a or 3b with no response to the lower layer 3 switch 3a or 3b with the response.

Then, the apparatus manager 104 updates the routing table registration statuses in the apparatus management table 133 (step St25). In this update, the routing table registration status of the lower layer 3 switch 3a or 3b registered in the routing table 131 is updated to “registered” and the routing table registration status of the lower layer 3 switch 3a or 3b deleted from the routing table 131 is updated to “not registered”.

In this way, in the case where no response or a failure notification message is received from the lower layer 3 switch 3a or 3b as the forwarding destination of the monitoring control packet addressed to the ring network 90, if a response is received from the non-forwarding destination lower layer 3 switch 3a or 3b (the forwarding status is “OK”), the upper layer 3 switch 1 switches the forwarding destination lower layer 3 switch 3a or 3b by updating the routing table 131. This operation is performed in the cases in FIGS. 9, 13, and 14.

When the forwarding status of the not-registered apparatus is “NA” (No in step St23), the processes in steps St24 and St25 are not executed.

When the update information is not the information indicating the update from “response” to “no response” for the IP address of the registered apparatus (No in step St21), the apparatus manager 104 determines whether the update information is information indicating an update from “no response” to “response” for the IP address of the registered apparatus (step St26). When the update information is the information indicating the update from “no response” to “response” (Yes in step St26), the apparatus manager 104 updates the forwarding status of the IP address of the registered apparatus to “OK” (step St27).

As described above, in the case where a response is once stopped from coming from the lower layer 3 switch 3a or 3b as the forwarding destination of the monitoring control packet addressed to the ring network 90 but thereafter a response again comes from the lower layer 3 switch 3a or 3b, the upper layer 3 switch 1 updates the forwarding status in the apparatus management table 133 to “OK”.

When the update information is not the information indicating the update from “no response” to “response” for the IP address of the registered apparatus (No in step St26), the apparatus manager 104 determines whether the update information is information indicating an update from “response” to “no response” for the IP address of the not-registered apparatus (step St28). When the update information is the information indicating the update from “response” to “no response” (Yes in step St28), the apparatus manager 104 updates the forwarding status of the IP address of the not-registered apparatus to “NA” (step St29).

As described above, in the case where no response or a failure notification message is received from the lower layer 3 switch 3a or 3b as the non-forwarding destination of the monitoring control packet addressed to the ring network 90, the upper layer 3 switch 1 updates the forwarding status in the apparatus management table 133 to “NA”. This operation is performed in the cases in FIGS. 11, 15, and 16.

When the update information is not the information indicating the update from “response” to “no response” for the IP address of the not-registered apparatus (No in step St28), the apparatus manager 104 determines whether the update information is information indicating an update from “no response” to “response” for the IP address of the not-registered apparatus (step St30). The apparatus manager 104 terminates the processing when the update information is not the information indicating the update from “no response” to “response” (No in step St30).

When the update information is the information indicating the update of “no response” to “response” (Yes in step St30), the apparatus manager 104 updates the forwarding status of the not-registered apparatus in the apparatus management table 133 to “OK” (step St31). Subsequently, the apparatus manager 104 determines whether the forwarding status in the apparatus management table 133 is “NA” for the IP address of the registered apparatus (step St32).

When the forwarding status in the apparatus management table 133 is “NA” (Yes in step St32), the path controller 105 registers the IP address of the not-registered apparatus into the routing table 131 (step St33). Along with this operation, the IP address of the registered apparatus is deleted from the routing table 131. Thus, the path controller 105 switches the forwarding destination of the monitoring control packet addressed to the ring network 90 from the lower layer 3 switch 3a or 3b with no response to the lower layer 3 switch 3a or 3b with the response.

Then, the apparatus manager 104 updates the routing table registration statuses in the apparatus management table 133 (step St34). In this update, the routing table registration status of the not-registered apparatus is updated to “registered” and the routing table registration status of the registered apparatus is updated to “not registered”.

In this way, in the case where a response is received from the lower layer 3 switch 3a or 3b as the non-forwarding destination of the monitoring control packet addressed to the ring network 90, if a response is not received from the forwarding destination lower layer 3 switch 3a or 3b (the forwarding status is “NA”), the upper layer 3 switch 1 switches the forwarding destination lower layer 3 switch 3a or 3b by updating the routing table 131.

When the forwarding status of the registered apparatus is “OK” (No in step St32), the processes in steps St33 and St34 are not executed.

As described above, the path controller 105 switches the forwarding destination of the monitoring control packet according to the updated data in the apparatus management table 133 for every transmission of a multicast packet. Thus, every time a multicast packet is transmitted, the upper layer 3 switch 1 is able to dynamically switch the forwarding destination of the monitoring control packet addressed to the ring network 90 according to the statuses of the lower layer 3 switches 3a and 3b.

In the above step St5, the request transmitter 101 transmits the multicast packet containing the request message to the lower layer 3 switches 3a and 3b.

Thus, the upper layer 3 switch 1 does not have to set the IP addresses of the lower layer 3 switches 3a and 3b, and the burden for the setting processing is saved. In contrast to this, for example, in the case of using ICMP echo requests as in the example of FIG. 2, the IP addresses of all the lower layer 3 switches 3a and 3b have to be set as destinations in advance, which places the burden of the processing of setting a large number of IP addresses in the upper layer 3 switch 1.

Next, operations of the lower layer 3 switches 3a and 3b are described.

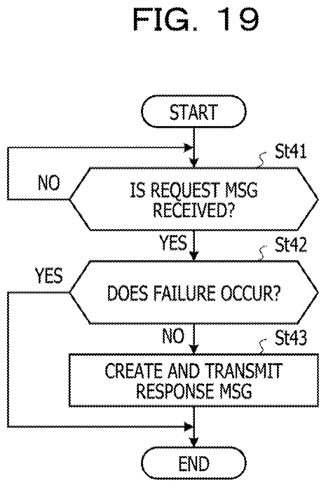

FIG. 19 is a flowchart illustrating an example of request message reception processing by the lower layer 3 switches 3a and 3b.

The request processor 301 determines whether a request message is received from the upper layer 3 switch 1 (step St41). When a request message is not received (No in step St41), the process in step St41 is executed again.

When a request message is received (Yes in step St41), the failure detector 303 determines whether a failure occurs in the forward path to the lower layer 3 switch 3c at the next node (step St42),

When no failure occurs (No in step St42), the response transmitter 302 creates a response message and transmits the response message to the upper layer 3 switch 1 (step St43). When the upper layer 3 switch 1 receives the response message, the upper layer 3 switch 1 is able to determine that the lower layer 3 switch 3a or 3b is currently able to forward a monitoring control packet (the forwarding status is “OK”).

When a failure occurs (Yes in step St42), the processing is terminated without transmitting a response message. When the upper layer 3 switch 1 does not receive the response message, the upper layer 3 switch 1 is able to determine that the lower layer 3 switch 3a or 3b is currently unable to forward a monitoring control packet (the forwarding status is “NA”). As described above, the request message reception processing is executed.

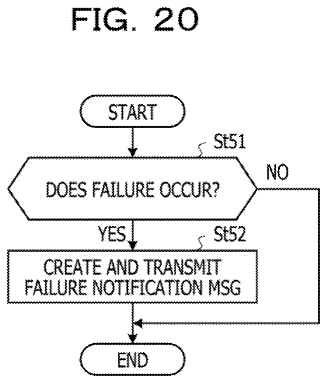

FIG. 20 is a flowchart illustrating an example of processing by the lower layer 3 switch 3a or 3b in the case where a failure occurs in the forward path between the lower layer 3 switch 3a or 3b and the lower layer 3 switch 3c at the next node.

The failure detector 303 determines whether a failure occurs in the forward path to the lower layer 3 switch 3c at the next node (step St51). When no failure occurs (No in step St51), the processing is terminated.

When a failure occurs (Yes in step St51), the response transmitter 302 creates a failure notification message, and transmits the failure notification message to the upper layer 3 switch 1 (step St52). When the upper layer 3 switch 1 receives the failure notification message, the upper layer 3 switch 1 is able to determine that the lower layer 3 switch 3a or 3b is currently unable to forward a monitoring control packet (the forwarding status is “NA”). As described above, the lower layer 3 switches 3a and 3b execute the processing at the occurrence of a failure.

In the present embodiment, the two lower layer 3 switches 3a and 3b are described as candidates for the forwarding destination of the monitoring control packet. Even in the case where there are three or more lower layer 3 switches, the forwarding destination is switchable in the same manner as above. In this case, the upper layer 3 switch 1 selects, as a forwarding destination, one of the lower layer 3 switches each having transmitted a response to a request message.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A packet forwarding apparatus comprising:
a transmitter configured to transmit a multicast packet requesting a response to a plurality of relay apparatuses each configured to relay a packet in a network;
a memory configured to store apparatus information relating to a relay processing status of the packet in each of the plurality of relay apparatuses; and
a processor configured to update the apparatus information according to whether the response is received from each of the plurality of relay apparatuses, and switch a forwarding destination of the packet from a relay apparatus with no response to a relay apparatus with the response among the plurality of relay apparatuses according to updated data in the apparatus information.

2. The packet forwarding apparatus according to claim 1, wherein the processor controls forwarding of the packet for monitoring control of the network.

3. The packet forwarding apparatus according to claim 1, wherein
the processor
repeats transmission of the multicast packet,
determines whether the response is received from each of the plurality of relay apparatuses every time the multicast packet is transmitted, and
switches the forwarding destination of the packet based on the updated data in the apparatus information for every transmission of the multicast packet.

4. The packet forwarding apparatus according to claim 1, wherein
when the relay apparatus as the forwarding destination of the packet among the plurality of relay apparatuses notifies the processor of the occurrence of a failure in a forward path for the packet to a next node in the network, the processor switches the forwarding destination of the packet to the relay apparatus with the response.

5. A network system comprising:
a packet forwarding apparatus configured to forward a packet for monitoring control of a network; and
a plurality of relay apparatuses each configured to relay the packet in the network, wherein
the packet forwarding apparatus includes
a transmitter configured to transmit a multicast packet requesting a response to the plurality of relay apparatuses,
a memory configured to store apparatus information relating to a relay processing status of the packet in each of the plurality of relay apparatuses, and
a processor configured to update the apparatus information according to whether the response is received from each of the plurality of relay apparatuses, and switch a forwarding destination of the packet from a relay apparatus with no response to a relay apparatus with the response among the plurality of relay apparatuses according to updated data in the apparatus information, and
each of the plurality of relay apparatuses transmits the response in response to reception of the multicast packet.

6. A packet forwarding method of forwarding a packet for monitoring control of a network, the method comprising:
transmitting a multicast packet requesting a response to a plurality of relay apparatuses each configured to relay the packet in the network;
determining whether the response is received from each of the plurality of relay apparatuses;
updating apparatus information relating to a relay processing status of the packet in each of the plurality of relay apparatuses, according to a result of the determination on whether the response is received from each of the plurality of relay apparatuses; and
switching a forwarding destination of the packet from a relay apparatus with no response to a relay apparatus with the response among the plurality of relay apparatuses according to updated data in the apparatus information.
